(19) United States
(12) Patent Application Publication
(10) Pub. No.: US 2026/0279388 A1
(43) Pub. Date: Sep. 17, 2026

(54) READ HEAD FOR A TURNTABLE

(71) Applicant: COMMISSARIAT A L'ENERGIE ATOMIQUE ET AUX ENERGIES ALTERNATIVES, Paris (FR)

(72) Inventor: Romain LIECHTI, Grenoble Cedex (FR)

(73) Assignee: COMMISSARIAT A L'ENERGIE ATOMIQUE ET AUX ENERGIES ALTERNATIVES, Paris (FR)

(21) Appl. No.: 19/564,734

(22) Filed: Mar. 12, 2026

(30) Foreign Application Priority Data
Mar. 12, 2025 (FR) FR2502476

(51) Int. Cl. G11B 3/31; G11B 3/20; G11B 3/38; G11B 3/46

(52) U.S. Cl. CPC G11B 3/31; G11B 3/20; G11B 3/38; G11B 3/46

(57) ABSTRACT

A read head comprising an electromechanical microsystem comprising: a stylus to engage with the microgroove of the LP record, a primary microbeam at a first of which the stylus is mounted, a first electromechanical transduction device extending from a second end of the primary microbeam, opposite the first end, and a second electromechanical transduction device extending from the second end of the primary microbeam. The first and second electromechanical transduction devices making it possible to convert a movement of the stylus into a first electric signal and a second electric signal, respectively for a first audio channel and a second audio channel.

### TECHNICAL FIELD

The present invention relates to the field of read heads for turntables.

### PRIOR ART

The LP record has seen a resurgence for fifteen years, with sales recently exceeding those of CDs, a first since 1987. The turntable read head market could exceed a billion dollars by 2030.

Read heads on the market are characterised by a certain number of parameters, the most important of which are as follows:
the frequency response, typically greater than 20 Hz to 20 kHz,
the signal-to-noise ratio, typically greater than 70 dB,
the voltage output level, typically around one millivolt, and
the channel separation, typically only 22 dB.

On the market, a price difference in read heads has been observed, varying from a few tens of euros to a few hundreds of euros for only a marginally better performance.

Entry level read heads, with a moving magnet, offer limited performance in channel separation, tracking, distortion and bandwidth. High-end models, based on a moving coil, are expensive and require a complete replacement when they are worn.

An aim of the present invention is to design a sensitive read head for a turntable, with high resonance frequency, with an excellent channel separation and a reduced manufacturing cost.

Other aims, features and advantages of the present invention will appear upon examining the following description and the accompanying drawings. It is understood that other advantages can be incorporated.

### SUMMARY

To achieve this aim, according to a first aspect of the invention, a read head for a turntable is provided, comprising an electromechanical microsystem, comprising:
a stylus intended to engage with the microgroove of the LP record,
a primary microbeam at a first end of which the stylus is mounted,
a first electromechanical transduction device extending from a second end of the primary microbeam, opposite the first end, and
a second electromechanical transduction device extending from the second end of the primary microbeam.

The first electromechanical transduction device and the second electromechanical transduction device make it possible to convert a movement of the stylus in a microgroove of the LP record, respectively into a first electric signal and a second electric signal, respectively for a first audio channel and a second audio channel.

A second aspect of the invention relates to a method for manufacturing a read head for a turntable, comprising:
providing a trench formed of a stack comprising a first silicon-based layer, a second silicon oxide layer electrically isolated on the first layer and a third superficial layer on the second silicon oxide layer,
etching the trench to obtain the read head,
in which a stylus of the read head is etched in the superficial layer and first and second electromechanical transduction devices of the read head are etched in the first layer.

The electromechanical microsystem technology appears, in this case, as an ideal solution, making it possible to design a sensitive read head, with high resonance frequency, with an excellent channel separation and a reduced manufacturing cost, thanks to a small surface on wafer. The signal-to-noise ratio can further be advantageously increased.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIG. 1 represents a top, perspective view of the read head according to an embodiment of the present invention.

FIG. 2 represents a top, perspective view of a part of the first electromechanical transduction device of the read head according to the embodiment of the present invention, which is illustrated in FIG. 1.

FIG. 3 represents a perspective view of a movement reduction lever according to an embodiment of the invention.

FIG. 4 represents a top view of an electromechanical transducer according to an embodiment of the present invention.

FIG. 5 represents a top view of an electromechanical transducer according to another embodiment of the present invention.

FIG. 6 represents a perspective view of the stylus mounted on the end of a primary microbeam according to an embodiment of the present invention.

FIG. 7 illustrates a cross-sectional view of a profile of the electromechanical microsystem according to an embodiment of the present invention.

FIG. 8 illustrates the path along which the profile of FIG. 7 has been extracted.

FIG. 9 illustrates a view of the read head according to an embodiment of the invention which engages with the microgroove of a record.

FIG. 10 illustrates a method for manufacturing a read head for a turntable according to an embodiment of the invention.

The drawings are given as examples and are not limiting of the invention. They constitute principle schematic representations intended to facilitate the understanding of the invention, and are not necessarily to the scale of practical applications.

### DETAILED DESCRIPTION

Before starting a detailed review of embodiments of the invention, optional features are stated below, which can optionally be used in association or alternatively:

According to an example, the first electromechanical transduction device and the second electromechanical transduction device are at least partially arranged substantially obliquely, even orthogonally, to one another.

According to an example, each electromechanical transduction device comprises:
A secondary microbeam configured to be set in motion along a main extension direction of the secondary microbeam during a movement of the stylus,
At least one mechanical spring in the anchored part on a frame and configured to deform, in order to enable the movement of the secondary microbeam along its main extension direction, and
An electromechanical transducer or equally a telecoil, configured to convert the movement of the secondary microbeam into an electric signal.

According to the preceding example, the secondary microbeam of the first electromechanical transduction device and the secondary microbeam of the second electromechanical transduction device are disposed symmetrically with respect to a main extension direction of the microbeam, when the electromechanical microsystem is not deformed.

According to any one of the two preceding examples, each electromechanical transduction device further comprises a movement reduction lever arranged between the secondary microbeam and the electromechanical transducer.

According to any one of the three preceding examples, each secondary microbeam has hinges configured to favour the movement of the secondary microbeam along its main extension direction and limit its movement transversally to the main extension direction of the secondary microbeam.

According to any one of the four preceding examples, for each electromechanical transduction device, said at least one mechanical spring comprises four mechanical springs anchored by one of their ends and disposed in pairs symmetrically with respect to the main extension direction of the secondary microbeam.

According to any one of the five preceding examples, each electromechanical transducer is a capacitive transducer, having, for example, a comb structure.

According to any one of the six preceding examples, each secondary microbeam and each mechanical spring are silicon-based, and in which each electromechanical transducer is doped silicon carbide-based, to be made conductive.

According to an example, the stylus is silicon carbide, SiC-based, optionally doped to be made conductive.

According to an example, the electromechanical microsystem is with the basis of a semiconductor material, such as silicon, optionally doped.

According to an example, the electromechanical microsystem has, perpendicularly to its main extension plane, a thickness greater of at least one magnitude to a width of the elements which compose the electromechanical microsystem. Thus, it is avoided that the electromechanical microsystem deforms in a direction perpendicular to its main extension plane.

According to an example of the second aspect of the invention, the third superficial layer is silicon carbide-based.

By “microbeam”, this means an element of an electromechanical microsystem, having an elongate shape in order to enable its bending or by twisting, according to its function. A microbeam has micrometric dimensions. It can have a millimetric dimension in its length.

By an element with the basis of a material A, this means an element comprising this material A, and optionally other materials.

By a parameter “substantially equal to/greater than/less than” a given value, this means that this parameter is equal to/greater than/less than the given value, plus or minus 20%, even 10%, of this value. By a parameter “substantially between” two given values, this means that this parameter is, as a minimum, equal to the smallest given value, plus or minus 20%, even 10%, of this value, and, as a maximum, equal to the greatest given value, plus or minus 20%, even 10%, of this value.

In reference to the accompanying figures, the read head 1 for a turntable 10 according to different embodiments of the invention is described below. In this case, it is noted that the microgroove typically has a depth of between 25 and 127 microns, for example, substantially equal to 28 microns.

The read head 1 according to the invention is mainly such that it comprises an electromechanical microsystem 11. An electromechanical microsystem can be defined as an electromechanical system having the following features: the mechanical structures typically have dimensions going from one micrometre to several centimetres, with layer thicknesses generally less than one millimetre, the components are made by micromanufacturing methods coming from microelectronics, such as photolithography, deposition of thin layers and/or etching. It is therefore understood that an electromechanical microsystem can be assimilated to an electromechanical system, the qualification “micro” being justified, in particular, by the micromanufacturing steps used.

In this case, it is noted that the electromechanical microsystem 11 can be with the basis of a semiconductor material, such as silicon, optionally doped. For example, the thickness e of the electromechanical microsystem 11, measured perpendicularly to its main extension plane, i.e. along, for example, the axis z of FIG. 8, is less than or equal to 1000 micrometres, and for example, substantially less than or equal to 750 microns. It is noted that the dimension of 750 microns corresponds to the typical thickness of a silicon-based substrate (commonly called “wafer”) for the semiconductor industry. The electromechanical microsystem 11 can thus have the same thickness e as a standard wafer.

The movement of the electromechanical microsystem 11 is done mainly along axes contained in its main extension plane, for example, along the axes x and y of FIG. 8.

All the dimensions indicated below refer to FIG. 8. In this case, it is noted that the electromechanical microsystem 11 has, for example, transverse dimensions of between 3 mm and 6 mm, and preferably around 5 mm, excluding frame 2. The thickness e of the electromechanical microsystem 11 can, for example, be measured along the axis z, between the lowest point of the stylus 111 and the highest point of the first electromechanical transduction device 113 or of the second electromechanical transduction device 114 along the axis z.

Preferably, the stylus 111, the primary microbeam 112, the first electromechanical transduction device 113 and the second electromechanical transduction device 114, each have a thickness measured perpendicularly to their respective main extension plane, i.e. along the axis z, these thickness are between 50 and 1000 micrometres, and even more preferably, substantially equal to 500 micrometres.

Preferably, at least the primary microbeam 112, the first electromechanical transduction device 113 and the second electromechanical transduction device 114, extend, preferably continuously, in the same main extension plane, i.e. in the main extension plane of the electromechanical microsystem 11. Preferably still, all the elements of the electromechanical microsystem 11 are located in the same main extension plane, i.e. in the main extension plane of the electromechanical microsystem 11. The electromechanical microsystem 11, due to the arrangement in the same plane as the primary microbeam 112 and as the transduction devices 113, 114, has a rigidity and is not very flexible along the axis z.

Preferably, the length Lₜ of the primary microbeam 112, measured along its main extension longitudinal axis, is between 200 and 6000 micrometres, and even more preferably this length Lₜ is substantially equal to 2000 micrometres. Preferably, the length Lₚ of the stylus 111 is between 50 and 2000 micrometres, and even more preferably, this length Lₚ is substantially equal to 700 micrometres. The longitudinal dimension of the stylus 111 can extend from the primary microbeam 112, for example, in its longitudinal continuity, and preferably directly, i.e. without a mechanical element being inserted between them. Preferably, the width lₚ of the stylus 111 is between 50 and 1000 micrometres, and even more preferably, this width lₚ is substantially equal to 500 micrometres.

Preferably, the lengths L₁, L₂ of the secondary microbeams 1131, 1141, measured along their respective main extension longitudinal axis, i.e. along the axes x and y, are each between 800 and 32000 micrometres. Preferably, the respective widths l₁, l₂ of the secondary microbeams 1131, 1141, measured, for example, along the axes x and y, are each between 200 and 20000 micrometres, and even more preferably, these widths l₁, l₂ are each substantially equal to 2000 micrometres.

The electromechanical microsystem 11 is therefore a mainly two-dimensional device extending, for example, into the plane (x, y), with a very limited three-dimensional movement, and in particular, along the axis z. This design of the electromechanical microsystem 11 is particularly advantageous for improving the reliability of the reading, in particular, thanks to the stability of the read head 111 along the axis z.

Preferably, the angles θ₁, θ₂ formed between the main extension longitudinal axis of each secondary microbeam 1131, 1141 and the main extension longitudinal axis of the primary microbeam 112 is substantially equal to 45 degrees.

Thus, in view of the dimensions described above of the elements of the device, it is understood that the electromechanical microsystem 11 can typically be obtained by micromanufacturing steps, such as etching, even if certain dimensions can reach 32 millimetres.

The electromechanical microsystem 11, at least concerning the stylus 111, the primary microbeam 112, the first electromechanical transduction device 113 and the second electromechanical transduction device 114, has a monolithic structure, i.e. that it comes from one single material piece, for example, the abovementioned wafer, being able, for example, to comprise one single layer or several layers secured to one another.

The electromechanical microsystem 11 can perform functions of the read head 1, going from the sensing of irregularities of the microgroove 101 by the stylus 111, up to the electromechanical transduction of each audio channel. More specifically, the electromechanical microsystem 11 does not play the roles of amplifying electric signals and returning these electric signals from it, even the role of equalising (RIAA) which must be done before amplifying the signal, these roles being played by an amplifier and a speaker not forming part of the electromechanical microsystem 11.

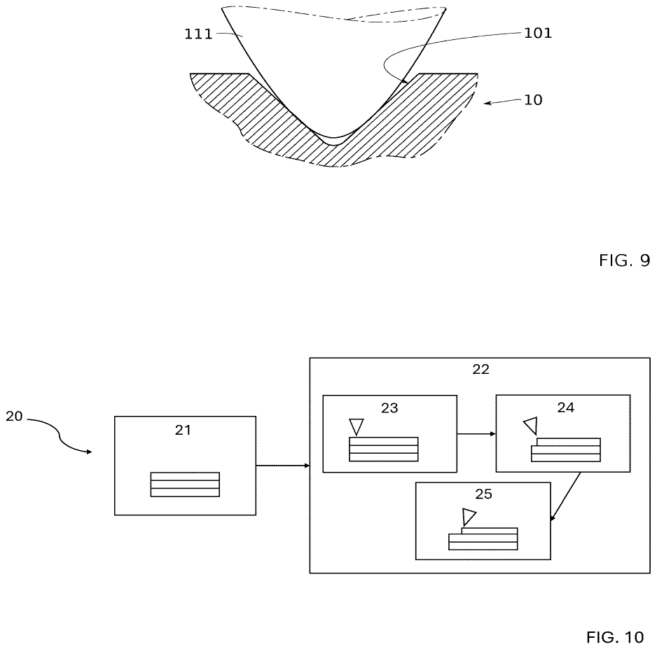

In reference to FIGS. 6 and 9, the stylus 111 is intended to engage with the microgroove 101 of the LP record 10. It is mounted on a so-called primary microbeam 112, and more specifically, on a first end 1121 of the primary microbeam 112. The read head 111 projects from the first end 1121 of the primary microbeam 112 so as to be able to engage with the microgroove 101 of the LP record 10. The read head 111 is, for example, silicon carbide-based, optionally doped to be made conductive.

The engagement between the stylus 111 and the microgroove 101 produces, when the record 10 rotates on the deck, a movement of the primary microbeam 112. The primary microbeam 112 can thus be designed, such that its dynamic movement, is for example, of an amplitude substantially equal to 100 microns. To reduce the distortion, the contact surface between the stylus 111 and the microgroove 101 can advantageously be relatively small. As illustrated in FIG. 9, the stylus 111 can be configured, such that the distance between the contact surfaces of the stylus 111 and the microgroove 101 is substantially equal to 25.4 microns. Moreover, the stylus 111 preferably has an elliptic shape.

Further to the stylus 111 and the primary microbeam 112, the electromechanical microsystem 11 further comprises two electromechanical transduction devices 113 and 114, one per audio channel.

The first electromechanical transduction device 113 extends from the primary microbeam 112, preferably from a second end 1122 of the primary microbeam, opposite the first end 1121, and is configured to convert a movement of the stylus 111 due to its engagement with the microgroove 101 of the LP record 10 into a first electric signal for a first audio channel.

The second electromechanical transduction device 114 extends also from the primary microbeam 112, preferably from the second end 1122 of the primary microbeam, and is configured to convert a movement of the stylus 111 due to its engagement with the microgroove of the LP record into a second electric signal for a second audio channel.

The primary microbeam 112, the first electromechanical transduction device 113 and the second electromechanical transduction device 114 are preferably integral, i.e. that they form a one-piece assembly.

Thus, it clearly appears that the read head 1 according to the invention makes it possible to process an audio content in stereo.

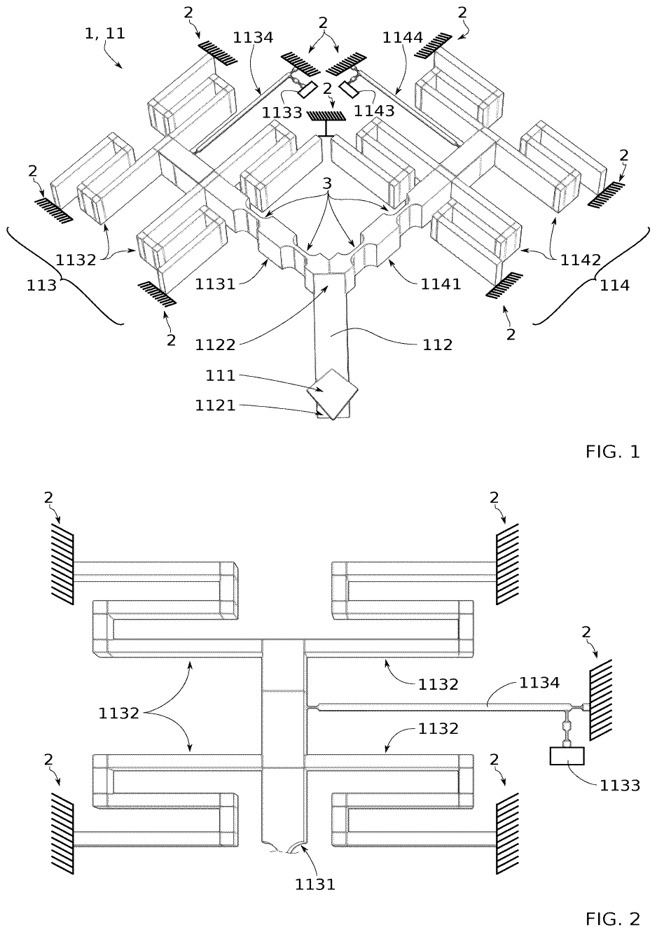

As illustrated in FIG. 1, the first electromechanical transduction device 113 and the second electromechanical transduction device 114 extend substantially obliquely, even orthogonally, to one another, from the primary microbeam 112. This configuration enables a great diagonal rigidity for a better channel separation. Preferably, the first electromechanical transduction device 113 and the second electromechanical transduction device 114 are disposed symmetrically with respect to a main extension direction of the primary microbeam 112, when the electromechanical microsystem 11 is not deformed, or when the stylus is in its rest position.

Thus, each of the two electromechanical transduction devices 113 and 114 is configured to convert the movement of the stylus 111 into an electric signal for a given audio channel.

Each electromechanical transduction device 113, 114 can more specifically comprise, from the primary microbeam 112, a secondary microbeam 1131, 1141, at least one mechanical spring 1132, 1142 and an electromechanical transducer 1133, 1143. For example, the secondary microbeams 1131 and 1141 together form an angle substantially equal to 90°.

Each secondary microbeam 1131, 1141 is configured to be set in motion substantially along its main extension direction during a movement of the stylus 111. To favour this movement, relative to a transverse movement of the microbeam 1131, 1141, the latter can have hinges 3. The hinges 3 make the cross-section vary of each secondary microbeam 1131, 1141. The hinges 3 are preferably arranged symmetrically. In the example illustrated in FIG. 1, each secondary microbeam 1131, 1141 comprises two hinges 3 located upstream of said at least one mechanical spring 1132, 1142.

Said at least one mechanical spring 1132, 1142 is partially anchored on a frame 2 in the way illustrated, in particular, in FIG. 2 and is configured to deform along the movement of the secondary microbeam 1131, 1141 considered. The frame 2 is configured to not deform due to the movement of the stylus 111 in the microgroove 101. The frame 2 can be constituted silicon-based and/or form part of the electromechanical microsystem 11.

As illustrated in FIGS. 1 and 2, said at least one mechanical spring 1132, 1143 can more specifically comprise four mechanical springs, each anchored on the frame 2 by a first end and arranged symmetrically to one another with respect to a main extension axis of the secondary microbeam 1131, 1141 considered. The conformity in the main extension plane is mainly given by the width of the folded springs 1132, 1142. The folded springs are preferably conform to decrease the rigidity in reduced dimensions and reduce the geometric non-linearities with an additional degree of freedom.

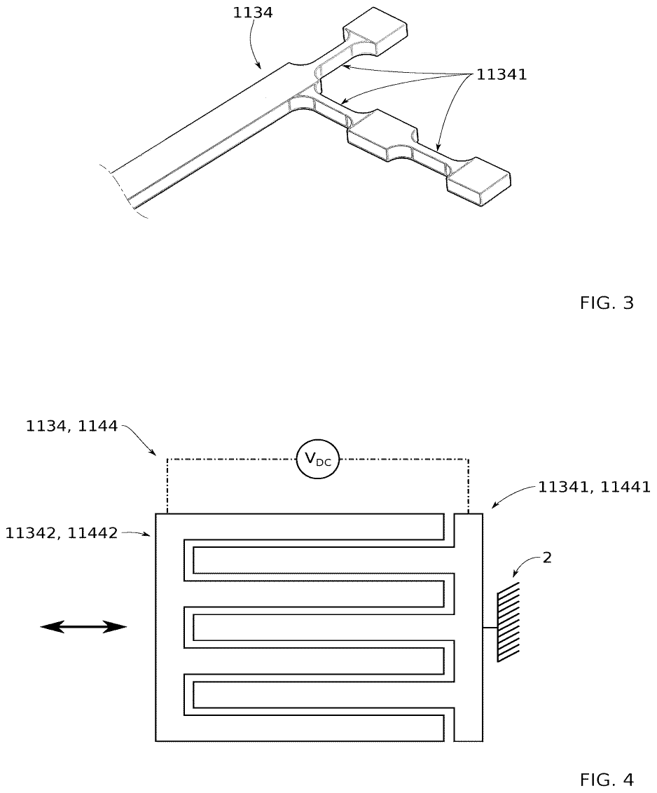

Each electromechanical transduction device 113, 114 can further comprise a movement reduction lever 1134, 1144 arranged between the secondary microbeam 1131, 1141 and the electromechanical transducer 1133, 1143. More specifically, the movement reduction lever 1134, 1144 is secured to the secondary microbeam 1131, 1141 by a first of its ends; it is anchored on the frame 2 by a second end, opposite the first; and it is mechanically connected to the electromechanical transducer 1133, 1143 by a tab extending substantially orthogonally with respect to a main extension direction of the movement reduction lever which extends between the first end and the second end of the movement reduction lever. As illustrated in FIG. 3, the movement reduction lever 1134, and the same applies for the movement reduction lever 1144, can comprise hinges intended to favour the deformation of the movement reduction lever, due to the movement of the stylus 111. Each movement reduction lever 1134, 1144 makes it possible to reduce the movement by a factor substantially equal to 30, to achieve a movement of around one micrometre.

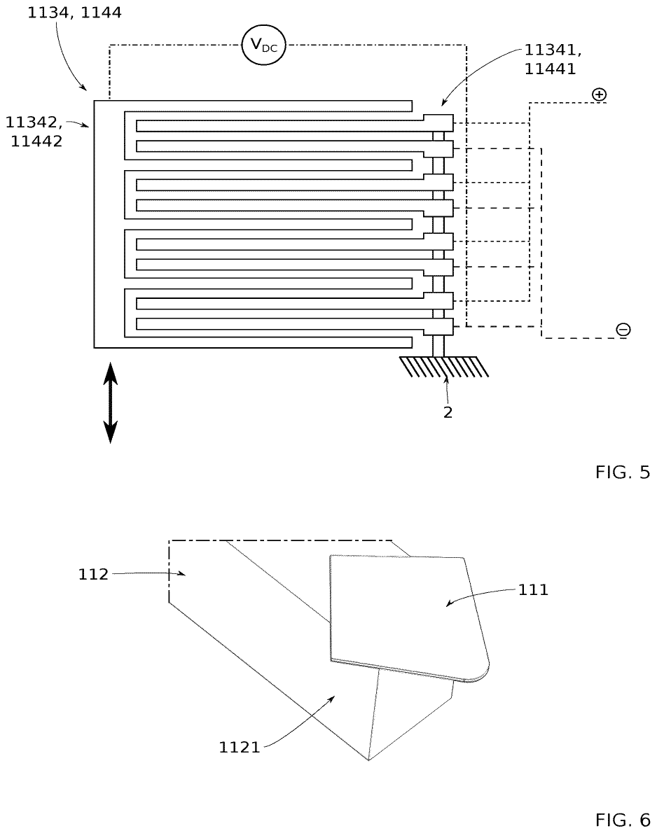

In reference to FIGS. 4 and 5, each electromechanical transducer 1133, 1143 can consist of a capacitive transducer. FIGS. 4 and 5 each illustrate an embodiment of the capacitive transducer which has a comb structure. A first part of each comb structure is anchored on the frame 2, while a second part of each comb structure and mechanically linked to the tab of the movement reduction lever 1134, 1144.

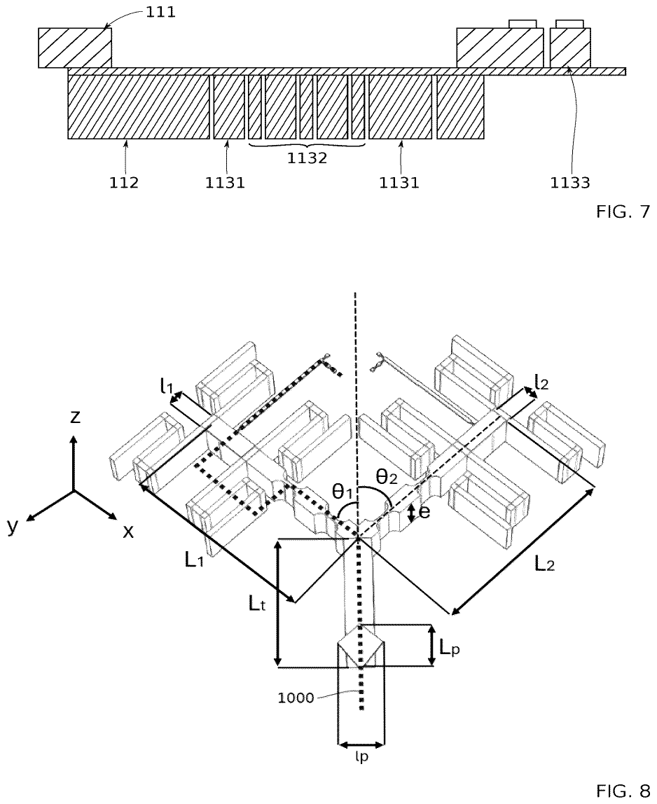

Another aspect of the invention relates to a method 20 for manufacturing a read head 1 such as described above and illustrated, for example, by FIG. 10. This manufacturing method 20, advantageously comprising conventional microelectronic steps, is described below in reference to FIGS. 7 and 8.

FIG. 7 represents the profile of the electromechanical microsystem 11 along the dotted line 1000 illustrated in FIG. 8.

It emerges from these illustrations that the method for manufacturing the read head 1 can start from the provision 21 of a trench formed of a stack comprising:
a first silicon-based layer,
a second electrically isolating silicon oxide layer on the first layer, and
a third superficial layer on the second silicon oxide layer.

The manufacturing method thus consists of etching 22 the trench to obtain the read head 1.

More specifically, the stylus 111 of the read head 1 is etched 23 in the superficial layer, while the first and second electromechanical transduction devices 113, 114 are themselves etched 24, 25 in the first layer. The third superficial layer is preferably silicon carbide-based, while the first layer is preferably silicon-based. For example, the etching 22 of the first layer consists of a deep reactive ion etching (DRIE). The silicon carbide layer, doped to be made conductive, can advantageously serve to each define electromechanical transducers 1133, 1143, which are in fact constituted of doped silicon carbide to be made conductive. It is thus easy to have reconnection pads, for example, made of gold, to link the electromechanical microsystem 11 to an amplifying stage of the turntable 10. The silicon dioxide layer makes it possible to perform the mechanical connection between the etched elements in the first silicon-based layer and the etched elements in the third superficial layer.

To achieve a flat frequency response in the audio band, the resonance due to the arm and the effective mass with which the read head 1 rests in the microgroove 101 can advantageously be less than the audio bandwidth, and/or the resonance of the read head 1, due to the conformity of the stylet and of the vinyl, can advantageously be greater than the audio range.

The read head can be statically charged by the arm and the counter-mass of the turntable. The typical value of this charge is 2 grams, which gives 19.6 mN, distributed over the two channels, which gives 13.85 mN per channel.

The static charge can lead to a movement of 0.35 μm.

All can be adjusted separately by design: the transduction factor, the axial rigidity, the moving mass, etc., to adapt to the resonance for a better reading.

The invention is not limited to the embodiments described above and extends to all the embodiments covered by the claims.

1. A read head for a turntable, the read head being obtained from a trench formed of a stack comprising a first silicon-based layer, a second electrically isolating silicon oxide layer on the first layer and a third superficial layer on the second silicon oxide layer, the read head comprising an electromechanical microsystem comprising:
a stylus with a basis of a material of the superficial layer to engage with a microgroove of an LP record,
a silicon-based primary microbeam, and at a first end of which the stylus is mounted,
a first silicon-based electromechanical transduction device, and extending from a second end of the primary microbeam, opposite the first end, and
a second silicon-based electromechanical transduction device, and extending from the second end of the primary microbeam, wherein
the stylus is mechanically connected with the primary microbeam the first electromechanical transduction device, and the second electromechanical transduction device by the second silicon oxide layer, and
the first electromechanical transduction device and the second electromechanical transduction device converting a movement of the stylus in the microgroove of the LP record respectively into a first electric signal and a second electric signal, respectively for a first audio channel and a second audio channel.

2. The read head according to claim 1, wherein the first electromechanical transduction device and the second electromechanical transduction device are at least partially arranged substantially obliquely to one another.

3. The read head according to claim 1, wherein each electromechanical transduction device comprises:
a secondary microbeam configured to set in motion along a main extension direction of the secondary microbeam during a movement of the stylus,
at least one mechanical spring partially anchored on a frame and configured to deform, in order to enable the movement of the secondary microbeam along its main extension direction, and
an electromechanical transducer configured to convert the movement of the secondary microbeam into an electric signal.

4. The read head according to claim 3, wherein the secondary microbeam of the first electromechanical transduction device and the secondary microbeam of the second electromechanical transduction device are disposed symmetrically with respect to a main extension direction of the primary microbeam, when the electromechanical microsystem is not deformed.

5. The read head according to claim 3, wherein each electromechanical transduction device further comprises a movement reduction lever arranged between the secondary microbeam and the electromechanical transducer.

6. The read head according to claim 3, wherein each secondary microbeam has hinges configured to favour the movement of the secondary microbeam along a main extension direction and limit its movement of the secondary microbeam transversally to the main extension direction of the secondary microbeam.

7. The read head according to claim 3, wherein, for each electromechanical transduction device, said at least one mechanical spring comprises four mechanical springs anchored by one of the ends and disposed in pairs symmetrically with respect to the main extension direction of the secondary microbeam.

8. The read head according to claim 3, wherein each electromechanical transducer is a capacitive transducer, having a comb structure.

9. The read head according to claim 3, wherein each secondary microbeam and each mechanical spring are silicon-based, and wherein each electromechanical transducer is doped silicon carbide-based to be made conductive.

10. The read head according to claim 1, wherein the stylus is silicon carbide, SiC-based, doped to be made conductive.

11. The read head according to claim 1, wherein the electromechanical microsystem is with the basis of a semiconductor material.

12. The read head according to claim 1, wherein the electromechanical microsystem has, perpendicularly to a main extension plane, a thickness greater of at least one magnitude to a width of the elements which compose the electromechanical microsystem.

13. A method for manufacturing a read head for a turntable, comprising:
providing a trench formed of a stack comprising a first silicon-based layer, a second electrically isolating silicon oxide layer on the first layer and a third superficial layer on the second silicon oxide layer, and
etching the trench to obtain the read head,
wherein a stylus of the read head is etched in the superficial layer, and first and second electromechanical transduction devices of the read head are etched in the first layer,
wherein a primary microbeam at a first end of which the stylus is mounted, is etched in the first layer,
the first electromechanical transduction device extends from a second end of the primary microbeam, opposite the first end, and
the second electromechanical transduction device extends from the second end of the primary microbeam.

14. The manufacturing method according to claim 13, wherein the third superficial layer is silicon carbide-based.
